(19) United States
(12) Patent Application Publication
(10) Pub. No.: US 2007/0168188 A1
(43) Pub. Date: Jul. 19, 2007

(54) Time-scale modification method for digital audio signal and digital audio/video signal, and variable speed reproducing method of digital television signal by using the same method

(76) Inventor: Won Yong Choi, Gyeonggi-do (KR)

Correspondence Address: NIXON PEABODY, LLP, 401 9TH STREET, NW, SUITE 900, WASHINGTON, DC, 20004-2128, US

(21) Appl. No.: 10/576,519

(22) PCT Filed: May 17, 2004
(86) PCT No.: PCT/KR04/01163

§ 371 Date: Jan. 31, 2007

(30) Foreign Application Priority Data
Nov. 11, 2003 (KR) 10-2003-0079610

(51) Int. Cl. G10L 19/14

(52) U.S. Cl. 704/211

(57) ABSTRACT

Problem: A method capable of ensuring a synchronization between an audio signal and a video signal both of which are modified in time-scale is needed. Solution: When analysis shift Sa=Ss/α, where Ss is synthesis shift and α is a designated time-scale (variable speed ratio), has a decimal value, two natural numbers which are nearest to the decimal value are selected as a modified analysis shift Sa′ and a compensated analysis shift Sa″, respectively. In time-scale modification of source audio samples to vary playback speed by dividing them into overlapped successive analysis windows, the modified analysis shift Sa′ and the compensated analysis shift Sa″ are alternately applied whenever a predetermined condition is met. The time difference between an estimated playback time and a real playback time of the time-scale modified audio signal is accumulated. The case that the predetermined condition is met is a case than an accumulated time difference goes beyond an upper threshold or a lower threshold of an allowed error range. In a processing of varying the playback speed of an AV signal, if a real variable speed ratio of a playback-speed-varied video signal is given as a target variable speed ratio of an audio signal to vary the playback speed of the audio signal, a synchronization between the video signal and the audio signal can be obtained. By applying this technology to the digital TV or TV phone, consecutive watch of the broadcasting signal for a phone-break time is possible. Catch-up for the currently received broadcasting signal is also possible through a high speed playback mode after a low speed playback mode initiated from a time of the past or the present.

### TECHNICAL FIELD

The present invention relates to the time-scale modification (“TSM”) of a digital audio signal. More specifically, the invention relates to a time-scale modification method, in which the reproduction time of the digital audio signal can be modified almost exactly proportional to a predetermined time-scale (or variable speed ratio) after the TSM processing, thereby maintaining almost perfectly the synchronization between the video and audio signals in a time-scale reproduction of a multi-media signal in reproduction.

### BACKGROUND ART

Since the overlap-add (“OLA”) method was introduced, the method to modify the reproduction speed of a digital audio signal in time domain has been developed into a synchronized overlap and add (“SOLA”) method and a waveform similarity based overlap and add (“WSOLA”) method, which are based on the OLA. The basic principle of these techniques lies in modifying the time-scale of the original digital audio signal by analyzing and synthesizing the input audio data stream.

According to the basic concept of the TSM method, when segmenting the data stream of the input audio signal into consecutive a plurality of windows (frames) of predetermined size, adjacent windows (frames) are overlapping with each other by an assigned length (analysis step). Then, if the value of time-scale α (a ratio of normal reproduction speed to modified reproduction speed, and assigned by a user) is given, overlapping areas of the adjacent windows in the a plurality of windows obtained during the analysis step are recalculated and added, depending on the value of α. In other words, according to the value of time-scale α, windows are concatenated after compressing or expanding the overlapping areas of the adjacent windows. When synthesizing the windows, a weighting factor is applied to the overlapping area to synthesize adjacent windows (synthesis step). The areas, which are not overlapping, are added as they are. Since the amount of audio data should be increased in order to slow down the reproduction speed of audio data stream, the overlapping length of adjacent windows of the TSM-processed output audio signal is compressed shorter than the original overlapping length. On the contrary, in order to speed up the reproduction speed, the overlapping length of adjacent windows of the TSM-processed output audio signal is expanded longer than the original overlapping length.

In the audio signal processing by the TSM method, the value of the time-scale α is defined by a ratio of synthesis interval Ss and analysis interval Sa theoretically, i.e., expressed as follows:
α=Ss/Sa (1)

where the synthesis interval Ss means the starting point interval of adjacent windows Wᵢ and WWᵢ₊₁ (or frame), when multiple continuous windows are realigned in the synthesis step, and the analysis interval Sa means the starting point interval of adjacent windows Wᵢ and Wᵢ₊₁ (or frame), when segmenting the original audio stream into a plurality of continuous windows in the analysis step. As the starting point interval of adjacent windows Wᵢ and Wᵢ₊₁ is represented by the number of audio samples, the synthesis interval Ss and the analysis interval Sa always have natural numbers.

In TSM processing, the time-scale α determined by a user and the synthesis interval Ss are given. So, the value of the analysis interval Sa is calculated by the equation (1). The computed value of the analysis interval Sa can be a decimal instead of a natural number according to Ss and α. However, as the analysis interval Sa cannot have a decimal value, it is inevitable to adopt the nearest natural number. For example, let the Sa value be 31.7 calculated by the equation (1), then the nearest lower (or higher) natural number 31 (or 32) is defined as the analysis interval applied practically, where the analysis interval applied practically is called ‘modified analysis interval’ and symbolized as Sa′.

However, if the digital audio data is processed by the TSM method by applying the modified analysis interval Sa′, the reproduction time error caused by the difference between the analysis interval Sa and the modified analysis interval Sa′ is accumulated, i.e. The TSM processing by applying the modified analysis interval Sa′ instead of the analysis interval Sa means that the applied time-scale α′ is different from the time-scale α given by the user, and the reproduction time error turns out as much as the difference of the values.

The reproduction time error can be accumulated continuously. In case of reproduction of audio signal only, the fact that the reproduction time of the TSM-processed audio signal is not accurately modified in proportion to the given time-scale α may not be a serious problem. In other words, when a user directs the time-scale modification twice as fast, even though the reproduction is time-scaled by 1.8 times or 2.2 times, the user does not realize the difference greatly and it would not be big a problem if it were not a situation which requires the exact 2 times accuracy.

However, in case of a time-scale modification of a multi-media signal comprising video and audio signals, if the time-scale of the audio signal is not exactly proportional to the assigned time-scale α, the audio signal and the video signal will be unsynchronized in the reproduction process. The increase of the accumulated error in reproduction time will leads to the ‘lip sync’ problem, where the sound does not accord with the lip. So a method is required to maintain the TSM-processed reproduction time accurately so as not to make a lip sync problem. To provide various useful time-scale modification functions for received digital broadcasting signals, it is absolutely necessary to guarantee the synchronization of the time-scaled audio and video signals.

### DISCLOSURE OF INVENTION

The present invention has been made to solve the above problems in the art, and it is an object of the invention to provide a TSM method for a digital audio signal, in which the real time-scale of a TSM-processed digital audio signal coincides with an assigned time-scale within a minute range of tolerance to an extent to be able to ignore.

Another object of the invention is to provide a TSM method for a digital audio signal, in which, when in the time-scale modification of a digital AV signal, the reproduction synchronization of a video signal and an audio signal can be well maintained.

A further object of the invention is to provide various additional functions by applying a TSM method of the invention to a digital broadcast signal.

In order to accomplish the above objects, according to one aspect of the invention, there is provided a time-scale modification method for a digital audio signal, in which an audio sample stream of an input signal is segmented into a plurality of overlapping analysis windows, the length of the overlapping area is changed into a length corresponding to an assigned time-scale α, and the overlapping area is weighted-synthesized to thereby be converted into a time-scaled output signal. The method of the invention comprises steps of: a) defining N+Kmax number of samples starting from an mSa^{th} sample (m:period index) of an input audio sample as an analysis window Wₘ of current period m, wherein, if a value of a desired synthesis interval Ss divided by the time-scale α is a natural number, the value is assigned as an analysis interval Sa, and if it is a decimal, two natural numbers nearest to the decimal are assigned respectively as a modified analysis interval Sa′ and a compensated analysis interval Sa″, the modified analysis interval Sa′ and the compensated analysis interval Sa″ being alternately applied in place of the analysis interval Sa every time when a certain desired condition is met; b) calculating a shift value Kₘ of the current period analysis window Wₘ when exhibiting a highest waveform-similarity between OV number of samples from the end of the output audio sample and OV number of samples of the current period analysis window Wₘ overlapping therewith, while shifting the starting point of the current period analysis window Wₘ by a certain predefined number of samples in a search range defined as Kmax number of samples from the OV+1^{th} sample counting from the end of an output signal of previous period m−1; c) defining N number of samples starting from the Km+1^{th} sample from the front of the current period analysis window Wₘ as an additional frame to be added to the current period, wherein an output signal of the current period m is synthesized by overlap-adding OV number of samples from the front of the additional frame to OV number of samples from the end of the previous period frame; and d) accumulating an error between a real reproduction time of the output signal of the current period In and a computed reproduction time calculated by the time-scale α, wherein, when the accumulated error is deviated from the upper or lower limit of an allowed error range, the certain desired condition is considered as being met.

The value of the time-scale α includes a time-scale assigned by a user-input device. Alternatively, a real time-scale of a video signal provided through a time-scale process of a video signal, which is carried out along with a time-scale modification of an audio signal, may be provided as a value of the time-scale α.

Preferably, the time-scale modification method of the invention may further comprise a step of, when the time-scale α is changed, recalculating an analysis interval Sa based on the changed time-scale, wherein a time-scale modification is processed using the changed time-scale and the recalculated analysis interval Sa.

In order to reduce the amount of computations for searching the maximum cross-correlation point Kₘ, it is preferable to skip plural samples when shifting the analysis window Wₘ within the search range Kmax at every period.

In the above time-scale modification method, the waveform-similarity may be determined by a cross-correlation between the overlapping area consisting of a certain number of samples from the end of the previous period frame and the certain number of samples of the current period analysis window Wₘ of the current period, which is overlapping with the previous period frame. In this case, preferably, among the samples of the previous period frame and the current period analysis window, a sample whose index is multiple of k (k: a natural number larger than 2) may be selected and participated in the computation of the cross-correlation.

According to anther aspect of the invention, there is provided a time-scale modification method for a digital audio/video signal, in which an input digital audio/video signal is separated into an audio signal and a video signal, each of which is time-scaled with a same time-scale α. The method of the invention comprises steps of: a) calculating periodically a real time-scale of a time-scaled video signal obtained by time-scaling the video signal based on the time-scale α; b) determining whether a real time-scale of a current period of the time-scaled video signal differs from that of a previous period, wherein, if different, the real time-scale of the current period is provided as a target time-scale α′, the target time-scale α′ becoming a reference for the time-scale modification of the audio signal; and c) segmenting a sample steam of the input audio signal into a plurality of overlapping analysis windows, changing the length of the overlapping area into a length corresponding to the target time-scale α′, and weighted-synthesizing the overlapping area, thereby modifying into a time-scaled output audio signal.

Here, in the above time-scale modification method for a digital audio/video signal, the time-scale modification of an input audio signal may be carried out the previously described TSM method for an audio signal.

In the above time-scale modification method for a digital audio/video signal, the real time-scale of the video signal is a ratio between an elapsed time T2-T1 from a certain point T1 in the past to a current time T2 and an elapsed time TS2-TS1 from a time stamp TS1 of a time-scaled video frame in the certain point T1 in the past to a current time stamp TS2 of a time-scaled video frame in the current time T2.

According to anther aspect of the invention, there is provided a method of reproducing a broadcast signal using an apparatus, which receive a transport stream of a digital television broadcast signal compressed and coded in a MPEG mode and reproduce a video and audio signals in real-time. This method of the invention comprises steps of: a) storing sequentially a digital television broadcast signal being received in a storage means at least after a user inputs a phone-break key; b) after the user presses a return key, reading the stored broadcast signal in a FIFO mode and time-scaling the respective retrieved video and audio signals with a predetermine time-scale, wherein, in particular, the time-scaling of the audio signal is performed based on a real time-scale α of the produced video signal, the real time-scale of the video signal is obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and c) outputting the time-scaled video and audio signals in place of a broadcast signal being currently received.

Preferably, the above method of reproducing a digital broadcast signal may further comprise a step of outputting a broadcast signal being currently received instead of the stored broadcast signal, if a time difference between a broadcast signal reproduced by applying the time-scale α as a value for a high speed reproduction mode and the broadcast signal being currently received falls within a certain desired error range.

In addition, it may further comprises a step of, when the phone-break period between the phone-break key input and the return key input exceeds the maximum storage time of the storage means, replacing with the broadcast signal being currently received the stored broadcast signal, in sequence from an earlier stored one, and changing the start address of the phone-break period into an address of a broadcast signal stored at the maximum storing time before from the current time.

According to anther aspect of the invention, there is provided a method of reproducing a broadcast signal using an apparatus, which receive a transport stream of a digital television broadcast signal compressed and coded in a MPEG mode and reproduce a video and audio signals in real-time. The method of the invention comprises steps of: a) storing sequentially the broadcast signal in a storage means; b) when a user's back-and-slow key input is detected, reading the stored broadcast signal in a FIFO mode, starting from a broadcast signal received before a certain period of time from that time point, and time-scaling the respective retrieved video and audio signals with a predetermine time-scale so as to enable a low speed reproduction, wherein, in particular, the time-scaling of the audio signal is performed based on a real time-scale α of the produced video signal, the real time-scale of the video signal is obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and c) outputting the time-scaled video and audio signals in place of a broadcast signal being currently received.

Preferably, the above method of reproducing a digital broadcast signal may further comprise steps of: a) when the user inputs a return key, time-scaling the stored broadcast signal for a high speed reproduction by modifying the time-scale into a value for a high speed reproduction mode, and b) outputting a broadcast signal being currently received instead of the stored broadcast signal, if a time difference between a broadcast signal being reproduced in a high speed mode and the broadcast signal being currently received falls within a certain desired error range.

According to another aspect of the invention, there is provided a method of reproducing a broadcast signal using an apparatus, which receive a transport stream of a digital television broadcast signal compressed and coded in a MPEG mode and reproduce a video and audio signals in real-time. The method of the invention comprises steps of: a) storing sequentially the broadcast signal in a storage means at least after a user inputs an immediate-slow key; b) reading the stored broadcast signal in a FIFO mode starting from the point of inputting the immediate-slow key and time-scaling the respective retrieved video and audio signals with a predetermine time-scale so as to enable a low speed reproduction, wherein, in particular, the time-scaling of the audio signal is performed based on a real time-scale α of the produced video signal, the real time-scale of the video signal is obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and c) outputting the time-scaled video and audio signals in place of a broadcast signal being currently received.

Preferably, the above method may further comprise steps of: a) when the user inputs a return key, time-scaling the stored broadcast signal for a high speed reproduction by modifying the time-scale into a value for a high speed reproduction mode, and b) outputting a broadcast signal being currently received instead of the stored broadcast signal, if a time difference between a broadcast signal being reproduced in a high speed mode and the broadcast signal being currently received falls within a certain desired error range.

In the forgoing three TSM methods for a digital broadcast signal, the time-scale modification of an audio signal may be carried out the TSM method for an audio signal previously described at the beginning of this section.

In addition, preferably, the above three TSM methods for a digital broadcast signal may further comprise a step of uncompressing and decoding the video and audio signals respectively by means of a MPEG decoder before time-scaling the broadcast signal stored in the storage means.

Furthermore, in the above three TSM methods, the time-scaling of the video signal may be performed by an adjustment of the output time interval of the video frames so as to be as fast as the time-scale, or a reduction of the number of output frames so as to be as low as the time-scale, or a combination of the above two. The adjustment of the output time interval of the video frames may be carried out an adjustment of the value of presentation time stamp of the video frame.

Various digital audio time-scale technologies have been known. However, those conventional techniques fail in commercialization, because they cannot obtain a synchronization of video and audio when applied to a multi-media signal.

The above problem can be solved completely by the present invention. According to the TSM processing of an audio signal of the invention, once a certain time-scale is assigned, the difference between a computed reproduction time corresponding to the assigned time-scale and a real reproduction time of the time-scaled signal by the time-scale can be controlled to remain within a pre-established tiny error range. Also, even if the time-scale changes, the audio signal is TSM-processed immediately using the changed time-scale. As a result, the audio signal obtained by the TSM processing of the invention is always maintained within a narrow error range to the extend to be able to disregard, as compared with the reproduction time computed using the time-scale assigned by the user. Therefore, the present invention can accomplish a synchronization of video and audio when applied to a multi-media signal. In particular, even though the value of the real time-scale of a time-scaled video signal may be deviated from the user assigned value, the TSM processing of an audio signal is adaptively performed based on the deviated value of time-scale, so that the AV synchronization in the time-scale processing needs less load. In addition, this AV signal synchronization results in useful and practical functions such as a “phone-break watch function”, a “back-and-slow watch function,” and a “immediate-slow watch function.”

The present invention may be programmed such that it can be included in a multimedia player for a personal computer, for example, can be embedded in the chip of the digital multimedia or the digital broadcast signal processor, such as a DVD player, a digital VTR, a TV phone, a PVR (personal video recorder), a MP3 player, a set-top box, etc.

### BRIEF DESCRIPTION OF DRAWING

Further objects and advantages of the invention can be more fully understood from the following detailed description taken in conjunction with the accompanying drawings, in which:

FIG. 1 is a diagram showing a time-scale modification (“TSM”) concept according to the present invention;

FIG. 2 is a diagram explaining a method to find a maximum waveform-similarity point between a current period frame and a previous period frame;

FIG. 3 is a flow chart showing specific execution procedures of a control method for suppressing the accumulated errors of reproduction time within a pre-assigned limit according to one embodiment of the invention;

FIG. 4 is a block diagram showing the basic configuration of an apparatus for carrying out a control method according to the invention;

FIG. 5 is a flow chart showing the execution procedures of a phone-break period watch function;

FIG. 6 is a flow chart showing the execution procedures of a back-and-slow watch function;

FIG. 7 is a flow chart showing the execution procedures of an immediate-slow watch function;

FIG. 8 is a block diagram showing a configuration of a system, which can provide the above additional functions by time-scaling digital television broadcast signals.

FIG. 9 is a block diagram showing a configuration of another embodiment different from the system in FIG. 8;

FIGS. 10a and 10b are diagrams showing the signal processing over time when executing the phone-break period watch function using a digital TV or a TV phone (generally referred to as a “digital TV”) which adopt the system in FIG. 8 or FIG. 9;

FIG. 11 is a diagram showing the signal processing over time when executing the back-and-slow watch function; and

FIG. 12 is a diagram showing the signal processing over time when executing the immediate-slow watch function.

### BEST MODE FOR CARRYING OUT THE INVENTION

Hereafter, the preferred embodiments of the present invention will be explained in detail with reference to the accompanying drawings.

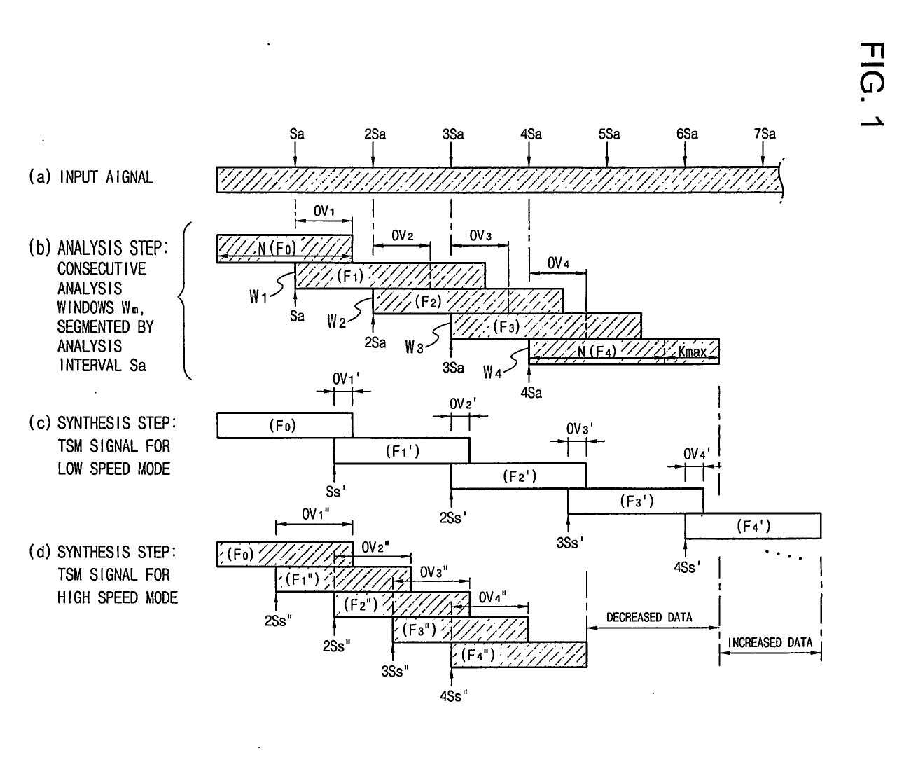

Before describing the invention, the TSM processing of an audio signal will be explained below for clear understanding of the invention. FIG. 1 is a diagram explaining the principle of the TSM method for a digital audio signal. The TSM method adopted by the invention segments the audio sample stream of an input signal into a plurality of overlapping analysis windows, converts the length of the overlapping area into a length corresponding to a requested time-scale, and synthesizes the overlapping area by applying a weighting factor. The TSM processing generally comprises an analysis step and a synthesis step.

In the analysis step, the digital audio signal sample stream shown in FIG. 1(a) is segmented into a plurality of continuous analysis windows Wₘ shown in FIG. 1(b). Here, the m is a natural number starting from one (1), and represents the cycle and the index of analysis windows. One analysis window Wₘ consists of N+Kmax samples including a frame of N samples and Kmax samples added thereto. In the analysis step, the starting point of each analysis window Wₘ is the mSa^{th} sample from the first sample of the input signal. Here, the Sa is called an analysis interval, which is the distance between the starting points of adjacent windows of a plurality of overlapping analysis windows.

FIGS. 1(a) and (b) illustrate the TSM-processed output signal in a low speed mode and a high speed mode, respectively. These output signals can be obtained by a synthesis step. In the synthesis step, the maximum waveform-similarity point is searched using the analysis window Wₘ. The samples used for synthesis are not all the samples in the analysis window, but N samples excepting Kmax samples in the searching range, that is, only the samples in one frame. The other remaining Kmax samples are discarded. Therefore, N samples are used to synthesize the output signal in every period. In the real synthesis process, as shown in FIG. 1(b), the analysis windows are realigned from the original overlap length OVₘ to a desired overlap length. In the TSM processing of low speed mode, as shown in FIG. 1(c), since the amount of data must be increased, the overlapping length OVₘ′ after the realignment becomes shorter than the overlapping length OVₘ before the realignment, so that the synthesis interval Ss′ becomes longer than the analysis interval Sa. In the TSM processing of high speed mode, as shown in FIG. 1(d), since the amount of data must be decreased, the overlapping length OVₘ″ after the realignment becomes longer than the overlapping length OVₘ before the realignment, and thus the synthesis interval Ss″ becomes shorter than the analysis interval Sa. In proportion to the change in the amount of data, the time needed to reproduce the signal is changed. The samples having the overlapping length OVₘ′ or OVₘ″ of relocated adjacent frames (a frame is part of the analysis window) are synthesized by applying the weighting factor. The ratio of the analysis interval Ss′ or Ss″ to the synthesis interval Sa must be identical to the value of the time-scale α. The equation (1) represents this relationship.

If the overlapping length of the adjacent frames is modified, discontinuity occurs. Therefore, noises can be included in the output signal due to the discontinuity of the adjacent frames. An effort is needed in order to minimize the noise caused by the discontinuity. It is difficult to minimize the noise simply by modifying the analysis interval Sa of the analysis window Wₘ to a synthesis interval Ss calculated according to the value of the time-scale α. In modifying and realigning the overlapping area of the adjacent frames, if the maximum waveform-similarity point of the overlap-added current period frame and the previous period frame is found out and then overlap-adds the frame from that point, discontinuity and consequently noises are minimized.

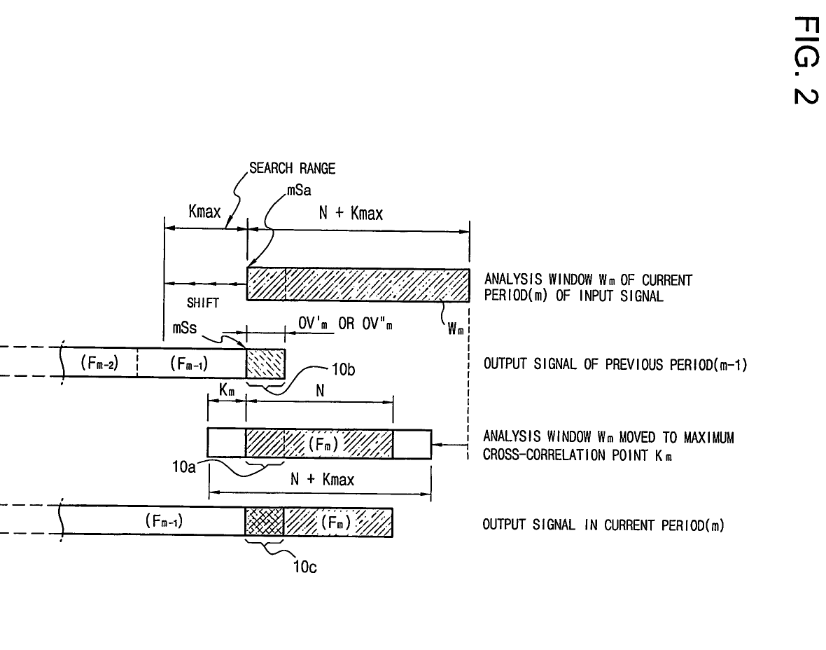

FIG. 2 is a diagram explaining a method to find the maximum waveform-similarity point between the current period frame and the previous period frame. The maximum waveform-similarity is determined by calculating the cross-correlation of samples in a certain area between the current period analysis window Wₘ and the previous period frame Fₘ₋₁. That is, the maximum waveform-similarity is searched by calculating the cross-correlation between the samples 10a, 10b in the overlapping area OVₘ′ (or OVₘ″) by overlapping the current period analysis window Wₘ with the previous frame Fₘ₋₁, then moving the starting point of the analysis window Wₘ through the search range Kmax. The method of calculating the cross-correlation is well known to those skilled in the art, who can select and apply an appropriate method. As illustrated in FIG. 2, samples in the OVₘ′ (or OVₘ″) from the end of previous frame Fₘ₋₁, which has become the output signal, constitute the overlapping area, and samples in the Kmax adjacent to the overlapping area constitute the search range. Then, within the search range, while shifting the m^{th} analysis window of the input signal, i.e. the current period analysis window Wₘ, by a predefined sample gap, the maximum cross-correlation point Km between the samples 10a, 10b in the overlapping area of the analysis window Wₘ and previous frame Fₘ₋₁ is searched. Once the maximum cross-correlation point Kₘ is searched, the current frame Fₘ, part of the analysis window Wₘ, is overlap-added to the end of the previous frame Fₘ₋₁. N samples excepting Kₘ samples at the beginning of the analysis window Wₘ and Kmax−Kₘ samples at the end thereof become the frame Fₘ, which is added as the current period output signal. Then, samples 10a, 10b belonging to the overlapping area OVₘ′ or OVₘ″ are synthesized by applying a weighting factor and the other samples in the current period frame Fₘ are added as they are. The samples, which do not participate in the synthesis, are ignored. In this way, the output signal of the current period is obtained. At the maximum cross-correlation point Kₘ, if the current period frame Fₘ is synthesized with the previous frame Fₘ₋₁, the least discontinuous connection can be obtained, thereby minimizing the noise caused by the frame realignment. The above TSM processing is carried out sequentially frame by frame.

When synthesizing samples in the overlapping area between the both sides of the analysis window Wₘ and the output signal, the reason why a weighting function is applied to the synthesis is to minimize the discontinuity of the signal in the overlapping area by connecting naturally the end portion of the output signal to the starting portion of the analysis window. As a typical example of the weighting function, the following linear ramp function can be used, but an exponential function or any other appropriate function can be selected alternatively.
g(j)=0, j<0; (2-1)
g(j)=j/Nm, 0≦j≦Nm; (2-2)
g(j)=1, j>Nm; (2-3)

A lot of computations are required to find the maximum cross-correlation point Kₘ. In many cases, a TSM method, which does not adopt a measure to reduce the amount of computations, is difficult to be executed on an embedded system processor due to the excessive amount of computations. The first scheme to reduce the amount of computations is to expand the shift interval of the analysis window Wₘ. I.e., even though the shift of the analysis window can be done by one sample, in order to reduce the amount of computations, it can be shifted by several samples at a time. If it shifts too many samples, the maximum cross-correlation point will be inaccurate. The amount of shift needs to be determined, considering the reduction of the amount of computations and the accuracy of the maximum cross-correlation point. The second approach to reduce the amount of computations is to limit the number of samples participating in the computation of the maximum cross-correlation point to part of the whole samples, instead of all samples in the overlapping area 10a, 10b. For example, from the overlapping area of the analysis window Wₘ 10a and the overlapping area of the previous frame Fm−1, only those samples whose sample indexes are a multiple of k (k is a natural number bigger than 2) are selected to compute the cross-correlation. If these two methods are applied together, the effect of computation reduction will be more increased.

In the synthesis step, the overlapping area 10a, 10b can be applied, in a fixed length, to any frame period. Alternatively, a different length of the overlapping area 10a, 10b may be applied to a different frame period. The length of the overlapping area 10a, 10b when the data of the overlap-added period 10c includes the minimum noise is determined as an optimal overlapping length. Coefficient of correlation may be used to find the optimum overlapping area. The coefficient of correlation Rxy is obtained using the following equation.
Rxy=[(Σxy)/(nσₓσ_{y})]·100% (3)

where x and y denote samples in the two overlapping areas 10a and 10b which participate in the computation of the coefficient of correlation, n denotes the number of samples of each parameter x and y both of which participate in the computation of the coefficient of correlation, and σₓ and σ_{y} denote the dispersion of parameter x and y, respectively. The coefficient of correlation can vary in the range of from −100[%] to +100[%], and the larger the value is, the higher the correlationship is. If the coefficient of correlation is in a range of 70%˜100%, it is evaluated as having a high correlationship. Therefore, it is desirable to apply the value of overlapping interval having more than 70% of the coefficient of correlation Rxy between the analysis window and the output signal. In this method, the amount of computations is increased to find the optimum overlapping length, but the quality of the output signal is enhanced. When high quality of sound is highly required, this method can be advantageously applied.

The method of reducing the amount of computation and varying the overlapping areas as explained above has been proposed and filed by the present applicant with PCT application Number PCT/KR02/01499 entitled “Audio signal time-scale modification method using variable length synthesis and reduced cross-correlation computations.” The TSM method claimed in the above PCT application can be preferably combined with the present invention. The technology disclosed in the PCT application can be understood by referring to its specification and drawings, and is incorporated here by reference. Therefore, further details will not be repeated here. The TSM method capable of being combined with the present invention is not limited to the invention of the above PCT application. As long as it is an algorithm of SOLA or WSOLA class for modifying the reproduction speed of an audio signal in the time-domain, all the TSM methods can be applied, including any TSM method to be newly developed in the future. If a TSM algorithm can synthesize an output signal exactly proportional to a predetermined value of the time-scale α, it can be more advantageously combined with the present invention.

Next, a method, in which a TSM-processed output signal is exactly proportional to a predetermined time-scale within an error range to the extent that it can be ignored, is explained.

In the TSM process of a digital audio signal, if the analysis interval Sa calculated from the equation (1) has a decimal value, it is inevitable to adopt the nearest natural number, because the unit of the analysis interval Sa, which is the number of samples, must be a natural number. Applying the modified analysis interval Sa′ instead of the computed analysis interval Sa results in a difference between the real reproduction time and computed reproduction time calculated by a predetermined time-scale. Here, the computed reproduction time means the reproduction time of an output signal obtained by calculation, assuming that the decimal value of analysis Sa is applied. If the analysis interval Sa calculated by the equation (1) is not a natural number but a decimal, the decimal part is discarded (or rounded up) and the remaining integer part is assigned as a value of the modified analysis interval Sa′ to be used practically. Application of the modified analysis interval Sa′ is the same as a TSM processing by using an inaccurate time-scale value α′ (i.e. modified time-scale), not the time-scale assigned by the user. Therefore, the real reproduction time of the TSM-processed output audio signal is different from that of the virtual output audio signal (referred to as a “computed reproduction time”) obtained by applying the time-scale assigned by the user. The difference is continually accumulated by TSM processing.

In the present invention, the above-accumulated error of reproduction time is controlled so as not to deviate from a predefined limit. That is, if the value of the predetermined synthesis interval Ss divided by the time-scale α is a natural number, the value is applied as it is. If the value is a decimal, however, the nearest two natural numbers are assigned as the modified analysis interval Sa′ and the compensated analysis interval Sa″ respectively. Whenever a predetermined condition is met, the modified analysis interval Sa′ and the compensated analysis interval Sa″ are used alternately, instead of the computed analysis interval Sa. The difference between the real reproduction time of the output signal in the current period and the computed reproduction time calculated by time-scale α is accumulated, and, if the accumulated error deviates from the allowed upper or lower limit, it is considered as a case of meeting the predetermined condition. It is desirable to determine the allowed error limits within the range that the watcher does not recognize the lip sync, i.e., unsynchronization between the audio and the video. The upper limit of the allowed error range, for example, may be determined within tens of milliseconds.

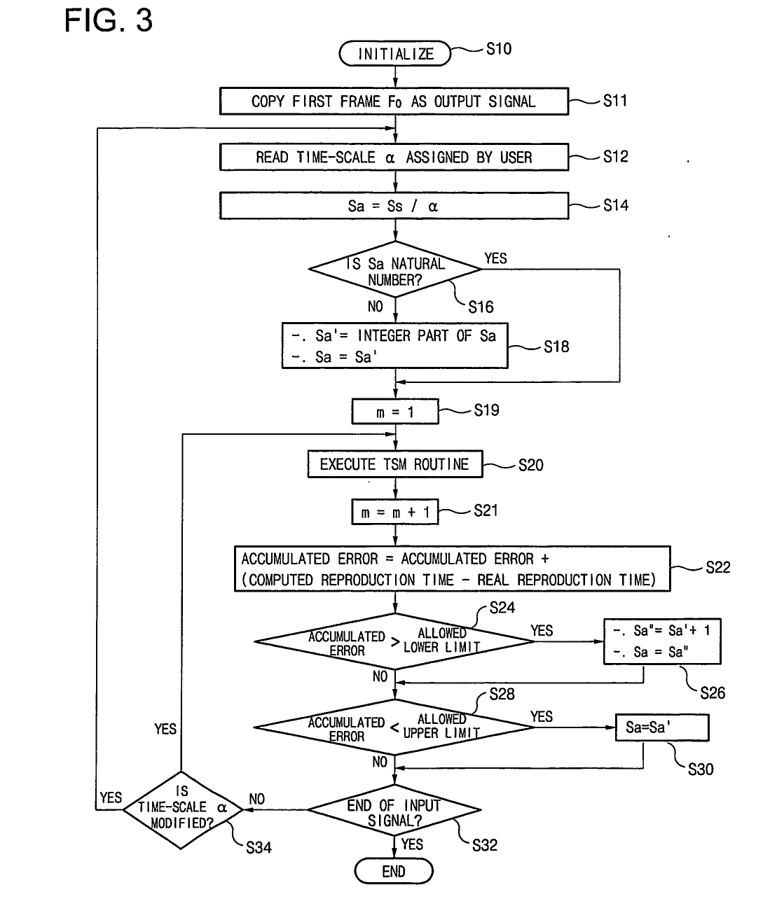

FIG. 3 is a flow chart illustrating the detailed execution procedures of the above control method. In the process of executing the TSM of the audio sample using the above-explained TSM method for the audio sample stream of the input signal (S20), the difference between the ‘real reproduction time’ and the ‘computed reproduction time’ is accumulated at the time when every single frame is TSM-processed (S22). And as soon as the accumulated error exceeds the upper or lower limit of the allowed error range, the error compensation is executed (S24, S26, S28, S30). The compensated analysis interval Sa″ is a parameter introduced in order to compensate the error made by the modified analysis interval. When executing the TSM routine (S20), if the value of computed analysis interval Sa is not a natural number, the accumulated error of the reproduction time is controlled so as not to deviate from the predefined error limits by applying appropriately the modified analysis interval Sa′ and the compensated analysis interval Sa″.

The process for calculating the modified analysis interval Sa′ is as follows. First, a TSM process is initialized (S10). In the initialization step, appropriate values are assigned to various parameters needed to execute the TSM routine, e.g. a frame size N, an overlapping length OV, an analysis interval Ss, a search range of the current analysis window (frame) against the previous window Kmax, and a time-scale α. In addition, a modified analysis interval Sa′, a compensated analysis interval Sa″, a reproduction time, and other parameters to be used to accumulate it are also initialized. After the initialization step, the first frame F₀ of the input signal is copied into the output signal as it is without being processed (S11), and the TSM routine is executed and modifies the time-scale from the second frame F₁. The value of time-scale α assigned by the user is read for this process (S12). If the user does not assign the value specifically, the value of time-scale α will be 1, which is assigned at the initialization step. Once the value of time-scale α is determined, the analysis interval Sa is computed according to the equation (1) (S14). Then, the computed analysis interval Sa is tested whether it is a natural number. If it is a natural number, the number is applied as it is when executing the TSM routine of the step S20 (S16). If the value is a decimal, the decimal part is discarded and the integer part is assigned as the modified analysis interval Sa′. The value of the analysis interval Sa applied in the TSM routine step (S20) is the modified analysis interval Sa′ (S18). Hereafter, instead of the computed analysis interval Sa, the modified analysis interval Sa′ is applied to the analysis interval in the TSM processing. According to the above procedures, a processing condition for the case where the computed analysis interval Sa has not a natural number is prepared.

In step S20, a TSM processing for the analysis window Wₘ of the current period is executed as explained above. I.e., a TSM processing for one analysis window is completed every time when one TSM routine (S20) is executed. Therefore, the value of the frame (or analysis window) index m starts from 1 and increments by 1 whenever the step S20 is completed (S19, S21).

After the completion of TSM processing for one window, the accumulated error of the reproduction time is calculated (S22). In order to calculate the accumulated error, the computed reproduction time and the real reproduction time until then must be calculated respectively. In a time domain, the reproduction time of the audio signal is proportional to the number of digital audio sample. Thus, the real reproduction time can be obtained by counting the TSM-processed digital audio samples. Alternatively, by using the timestamp of TSM-processed digital audio samples, the reproduction time of audio signal may be obtained. The above computed reproduction time, if the time-scale α assigned by a user is applied, can be obtained by counting the number of samples to be TSM-processed until the current period. In this way, the computed reproduction time and the real reproduction time are obtained, and the difference of the two is calculated. By adding the difference to the accumulated error of the reproduction time until the previous period, the new accumulated error of the reproduction time until the current period is calculated.

After the accumulated error of the reproduction time is updated, the value is checked whether it exceeds the upper limit (e.g. +5 ms) (S24). In the step S24, if the result is true, the compensated analysis interval Sa″ is calculated (S26). The compensated analysis interval Sa″ is applied from the next frame in order to reduce the accumulated errors. If the modified analysis interval Sa′ is determined by discarding the decimal part of the decimal value of the computed analysis interval Sa, the compensated analysis interval Sa″ can be determined by adding 1 to the modified analysis interval Sa′. If the modified analysis interval Sa′ is determined by rounding up the decimal part of the decimal value of the computed analysis interval Sa, the compensated analysis interval Sa″ can be determined by subtracting 1 from the modified analysis interval Sa′. For example, if the value of the computed analysis interval Sa is 31.7 and the modified analysis interval Sa′ is determined to be 31 (or 32), the compensated analysis interval Sa″ is determined to be 32 (or 31). For the more prompt error compensation, a larger value such as 2 or 3, rather than 1, can be used as the value to add to or subtract from the modified analysis interval Sa′ in order to obtain the compensated analysis interval Sa″. In this way, after calculating the compensated analysis interval Sa″ and allocating it to the analysis interval Sa, the analysis interval is used when executing the TSM routine (S20) from the next frame period.

During the repetition of the TSM processing while applying the compensated analysis interval Sa″, the accumulated error of the reproduction time continues to decrease to near zero and then increase toward the opposite sign to finally deviate the lower limit (e.g. −5 ms) of the allowed error range. At this point, the analysis interval Sa, which will be applied to execute the TSM routine, is replaced again by the modified analysis interval Sa′, instead of the compensated analysis interval Sa″, which has been used until then. This processing is carried out in the steps S28 and S30. After the modified analysis interval Sa′ is applied, the accumulated error of the reproduction time increases again, and consequently exceeds the upper limit of the allowed error range. Then, the compensated analysis interval Sa″ is used again. In this way, in case where the computed analysis interval Sa is not a natural number, two natural numbers nearest to the computed analysis interval Sa are assigned respectively as the modified analysis interval Sa′ and the compensated analysis interval Sa″, and the modified analysis interval Sa′ and the compensated analysis interval Sa″ are alternately applied, in place of applying the computed analysis interval Sa. Whenever the accumulated error of the reproduction time exceeds the upper and lower limit of the error range, the modified analysis interval Sa′ and the compensated analysis interval Sa″ are used alternately.

According to the control method as mentioned above, the real reproduction time of the TSM-processed output signal swings within a fixed range based on the computed reproduction time, which is calculated by the predetermined time-scale. If the control method of the invention is applied to the time-scale reproduction of an AV signal provided that the allowed error range is established so as to maintain so-called lip sync, the synchronization of the AV signal can be achieved almost perfectly to a degree that a person cannot recognize the synchronization error of the AV signal.

On the other hand, the process for one analysis window is completed while passing through the steps S20 to S30. At this point, it is checked whether there exist more audio samples of input signal to be processed. If there is no more input signal, the routine terminates immediately. Otherwise, it returns to the step, in which the next analysis window is to be processed. During the return process, the value of time-scale α is checked whether it has been changed (S34). If the time-scale α has not been changed, the routine returns to the execution step of TSM process (S20) and repeats the TSM process for the analysis window Wm+1 in the same way as above. If the time-scale α has been changed, it returns to the step S20, where the analysis window interval Sa, the modified analysis window interval Sa′, and the other parameters should be recalculated, due to the change in the time-scale α (S34).

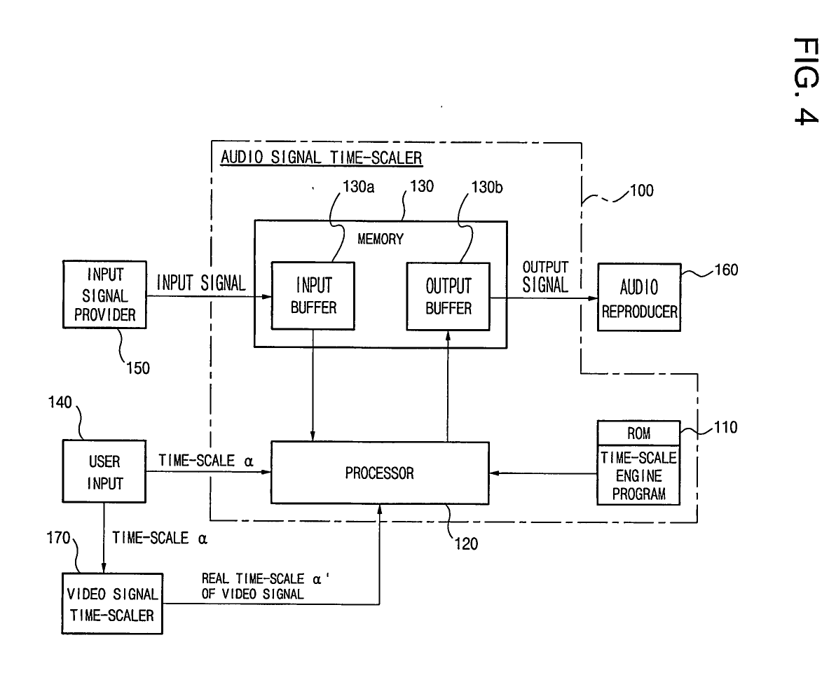

These control method and TSM method can be embodied in the form of a software engine. The software engine may be loaded into the memory and executed on the processors such as CPU, DSP, microprocessor, and audio decoder chip. The basic configuration of an apparatus for carrying out the method of the present invention is illustrated in FIG. 4. As illustrated, the apparatus requires a non-volatile memory 110 such as ROM or flash memory for storing the engine program, a processor 120 for executing the engine program and converting an input signal to a TSM-processed output signal, and a memory 130 for storing data before and after the TSM processing. As an example, the processor 120 may be embodied as a DSP, a micro-com, or a CPU unit, or it may be a special-purposed audio chip, audio/video chip, MPEG chip, or DVD chip. The memory 130 provides an input buffer 130a for storing the input signal temporarily, an output buffer 130b for storing the output signal after the TSM processing, and also provides space needed for the various operations and data processing by the processor 120. In addition, a user-input device 140, e.g. an input keypad or a remote controller, is needed to convey the time-scale α entered by a user to the processor.

Before TSM processing, an input signal from an input signal provider 150, such as a CD-ROM, a hard disk, and a decoding chip, is stored temporarily in the input buffer 130b of the memory 130 and then TSM-processed 120 by the processor 120. The TSM-processed signal is stored in the output buffer 130b temporarily and transferred to an audio reproduction unit 160 to be played through a speaker by way of a D/A conversion process.

If the TSM method is applied to an AV device, the synchronization of the AV signal can be achieved. It is because the TSM method of the present invention enables the reproduction time of the time-scaled audio signal to be almost exactly proportional to the given time-scale. As another reason, in the TSM method of the present invention, once the time-scale is changed, immediately the next frame is TSM-processed, based on the changed time-scale. When time-scaling an AV signal, over time, the real time-scale of the time-scaled video signal may become different from the time-scale α assigned by the user. In this case, if the time-scale processing of the audio signal is performed according to the time-scale assigned by the user, the synchronization of the time-scaled AV signals is not maintained. In case of time-scaling an AV signal, time-scaling of one signal must be performed based on the real time-scale of the other time-scaled signal, in order to maintain the synchronization of AV signal. The present invention proposes a method of utilizing a real time-scale of time-scaled video signal as a reference time-scale for time-scaling an audio signal by transferring the real time-scale of time-scaled video signal to the TSM process of the audio signal. By using this method, synchronization of the time-scaled AV signal is accomplished.

More specifically, the concept of a target time-scale is introduced. The real time-scale, which is observed in the reproduction process of the time-scaled signal, can vary with time, and the target time-scale is a reference time-scale, which is pursued continually by the varying real time-scale. When only the audio signal is reproduced, the time-scale α assigned by the user becomes the target time-scale. However, in case of reproducing time-scaled AV signals with AV equipment, the real time-scale of a video signal can be adopted as the target time-scale whose value can vary. In the TSM processing of an audio signal, the real time-scale of the video signal can be regarded as a time-scale assigned by the user.

Let it be assumed that the video and audio signals of an AV signal are time-scaled separately by the audio signal time-scale processor 100 and the video signal time-scale processor 170 according to the same time-scale assigned by a user (refer to FIG. 4). In order to maintain the synchronization between the video signal and the audio signal, the TSM of the audio signal is processed based on the real time-scale of the Video signal. I.e., if the value of the real time-scale of the video signal changes, then, the time-scaling of the audio signal is processed by modifying the time-scale, which is a reference when in the TSM processing of the audio signal, to the changed value of the real time-scale of the video signal. Specifically, the video signal time-scale processor 170 calculates the real time-scale of the time-scaled video signal periodically, and checks whether the calculated time-scale has the same value as the time-scale calculated previously. If the two time-scales are different, a newly computed time-scale is provided to the audio signal TSM processor 120. As an alternative, the video signal time-scale processor 170 calculates the real time-scale of the video signal periodically and transfers it to the processor 120 of the audio signal time-scale processor 100, and the processor 120 of the audio signal time-scale processor 100 may test if the time-scale has been changed. Whatever method is used, the confirmation as to whether the real time-scale of the video signal is changed can be carried out at the step S34, in which it is checked if the time-scale is corrected by the user. If the real time-scale of the video signal, i.e. the target time-scale α′, has been changed, the procedures from S12 to S32 are performed, for example, returning to the step S12, reading the changed target time-scale α′, and recalculating the analysis interval Sa, etc. If the target time-scale α′ has not been changed, it goes to the step S20.

In this way, in case of time-scaling an AV signal, if the audio signal is TSM-processed using the real time-scale of the video signal as the target time-scale, which is a reference for the audio signal time-scale, the synchronization of the AV signal can always be maintained. For example, let it be assumed that the time-scale assigned by a user is 2 (i.e., twice fast reproduction). After starting the time-scaled reproduction of the AV signal based on this value, it can be assumed that the real time-scale of the video signal in a certain period became 2.1 for some reason. In this case, the audio signal time-scale processor 100 receives the real time-scale value 2.1 of the video signal from the video signal time-scale processor 170, but regards it as a time-scale assigned by the user. Therefore, the target time-scale is changed from 2.0 to 2.1 in the time-scaled reproduction of the audio signal. Then, based on the changed value, the analysis interval Sa, the modified analysis interval Sa′, and the compensated analysis interval Sa″ is recalculated. By applying these values, TSM of the audio signal is processed.

In case of an MPEG signal, the real time-scale (i.e. the target time-scale) of the time-scaled video signal may be calculated from the time stamp. The video signal time-scale processor 170 can read the time value from the time stamp of the current time-scaled video frame. Thus, if the time stamp TS1 of the time-scaled video frame at a certain point in the past T1 and the time stamp TS2 of the time-scaled video frame at the current time T2 are known, the real time-scale of time-scaled video signal av can be calculated from the equation (4). That is, the real time-scale of the video signal is the ratio of the real elapsed time T2-T1 from a certain point T1 in the past to the current time T2 to the difference between the time stamp TS1 of the time-scaled video frame at T1 and the time stamp TS2 of the time-scaled video frame at T2. The calculated value is applied as a new target time-scale α′ in the time-scaled reproduction of the audio signal.
αᵥ=α′=(TS2−TS1)/(T2−T1) (4)

In this way, according to the present invention, the video signal is time-scaled according to the time-scale assigned by a user, and the audio signal is time-scaled based on the real time-scale of the video signal. Accordingly, the synchronization of the AV signals is achieved while time-scaling, i.e., the audio reproduction speed can be coincided with the video reproduction speed regardless of the real reproduction speed of the video signal. As a result, the synchronization between the time-scaled audio and video signals can be well maintained.

On the other hand, the TSM technology for audio signal and the synchronization technique for AV signal of the invention as explained above may be combined with the well known time-scale reproduction techniques for video signal to apply to the time-scale reproduction of digital broadcast signal, thereby further providing various useful functions.

The first one of the useful additional functions is exemplified by a “phone-break period watch function.” According to this function, the broadcast signal is stored while one cannot watch the television, for example, because of using a toilet or a phone call (it is called a “phone-break period”), and, after the phone call, the stored broadcast signal can be replayed from the start of the phone-break period sequentially in a high speed mode. Then, when the stored broadcast signal catches up with the current broadcast signal, the output signal is replaced by the broadcast signal currently being received. By using this function, the broadcast signal can be watched continuously without a break.

The second one of the additional functions is a “back-and-slow watch function.” When one wants to watch the previous contents in detail while watching television, this function replays from the scene concerned sequentially in a low or a normal speed mode. Afterwards, the stored broadcast signal can be replayed in a high speed mode for a normal watch, and switched to the current broadcast signal when it catches up with the current broadcast signal.

The third one of the additional functions is an “immediate slow function.” This is useful to watch in detail the current broadcast signal, stores the broadcast signal being received in the storage device at least from the present scene and replays the stored broadcast signal in a low speed mode at the same time, and switches to the current broadcast signal when it catches up with the current broadcast signal.

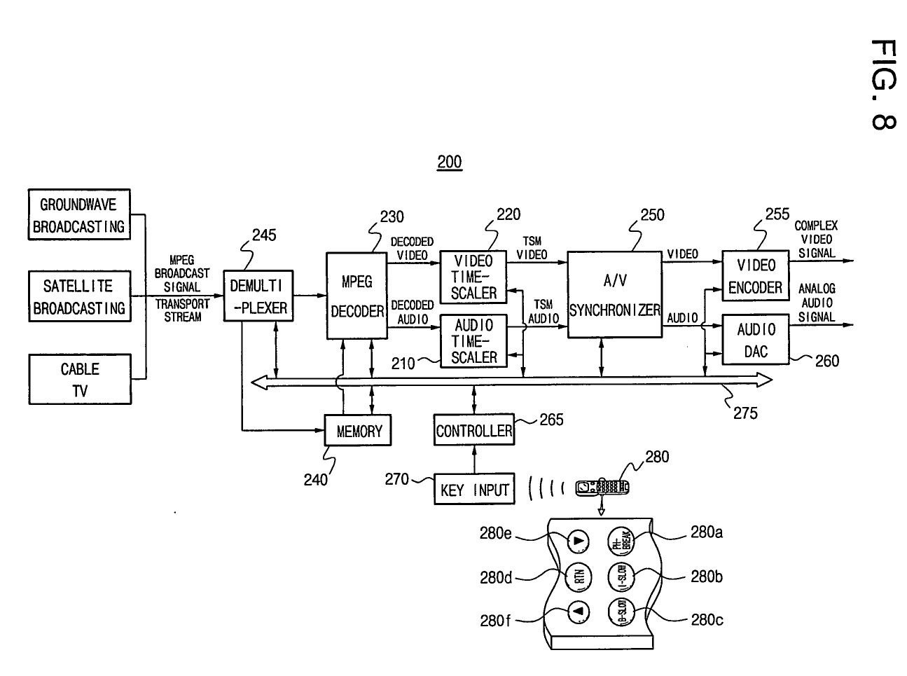

These functions can be established under the condition that the broadcast signal being received can be stored in a data storage medium such as a memory or a hard disk. Therefore, an apparatus for carrying out these functions needs to be equipped with a storage device for the digital broadcast signal and a time-scale processing method for the audio and video signal. FIG. 8 is a block diagram depicting the configuration of a system 200, which can provide the above additional functions by time-scaling the digital television broadcast signal. This system 200 can be embedded in a digital television set, a TV phone with a built-in digital broadcast receiver, a personal video recorder (PVR), a set-top box, and the like.

The processes performed in the system of FIG. 8 are briefly described below. Video signals may be digitized and packetized, and then multiplexed with relevant audio signals and/or data channels. The data channel can be either closely related with relevant videos or not related at all. These multiplexed signals are called a digital broadcast signal (or a broadcast program). In addition, plural broadcast programs can be multiplexed into a single transport stream. Digital broadcast signals are provided to a digital TV in the form of a transport stream, which is compressed and coded according to the MPEG standards. The digital broadcast signals are served to the TV audience by ground wave broadcasting, satellite broadcasting, a cable television, or the like. Once a television receives a signal, the video, audio and other information is demultiplexed by a demultiplexer 245 and transferred to a MPEG decoder 230. Concurrently, it is stored in a memory 240 in order to provide the above functions. Here, the memory 240 is a typical example of a storage device for broadcast signals. Of the two data sources of the MPEG decoder 230, one is the current broadcast signal provided directly through the demultiplexer 245 and the other is the broadcast signal received previously and stored in the memory 240. A controller 265 controls which source data is to be provided to the MPEG decoder 230. The MPEG decoder 230 separates the MPEG broadcast signal into a video signal and an audio signal, then decompresses and decodes the signals respectively. The decoded data becomes a PCM data. In case where the time-scaling is not needed, the decoded video and audio signals are transferred to an A/V synchronizer 250 separately. The A/V synchronizer 250 synchronizes the video signal and the audio signal. The synchronized video and audio signals are transferred to a video encoder 255 and an audio digital-analog converter (DAC) 260 to be converted into an analog video and audio signals respectively, and finally output as a moving picture and a sound through a display or a speaker. If the display device is a digital driven display device such as an LCD or a PDP, there needs a separate driver circuit, instead of the video encoder 255. Each element is connected through a bus (275).

In order to carry out the above-described three functions, the time-scale processing for the audio and the video signals should be performed. For this, the decoded video and audio signals from the MPEG decoder 230 are supplied to a video time-scaler 220 and an audio time-scaler 210, in which they are time-scaled and provided to the A/V synchronizer 250. A user input device such as a remote controller 280 or a keypad 270 is provided with a key to instruct the above three functions. As depicted, for example, the remote controller 280 is provided advantageously with a phone-break key 280a for the “phone-break period watch function”, an immediate slow key 280b for the “immediate slow function”, a back and slow key 280c for the “back and slow watch function, a return key 280d for catching up with the broadcast signal, and an up and down key 280e, 280f for increasing or decreasing the replay speed, etc.

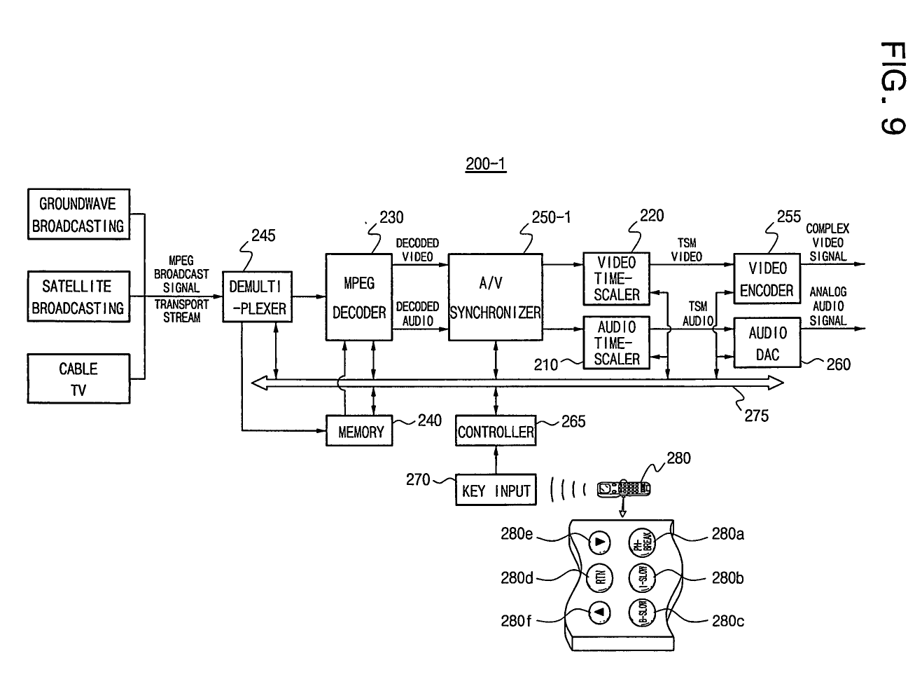

FIG. 9 is a block diagram showing a configuration of another system 250-1 different from the system in FIG. 8. The system 200-1 in FIG. 9 differs from the system 200 in FIG. 8 in that an A/V synchronizer 250-1 is located in between the MPEG decoder 230 and the two time-scalers 220, 210. The system 200 in FIG. 8 processes the synchronization of the video and audio signals after the time-scaling, while the system 200-1 in FIG. 9 synchronizes the video and audio signals before the time-scaling.

In the systems depicted in FIGS. 8 and 9, the memory 240 is a typical example of a storage media for the broadcast signal being received, and can be a RAM. The broadcast signal, which is a digital signal compressed and decoded in an MPEG mode, has particularly a lot of video signal data. Accordingly, a large capacity of RAM is required to store the broadcast signal of long time, thereby increasing the costs. Therefore, in cases of a digital TV, and a set-top box or a personal video recorder (PVR), which are used in combination with a digital TV, it is preferable to use a low cost mass storage device such as a hard disk as the memory 240. In addition, a combination of a hard disk and a RAM may be used for the memory 240. Although the systems depicted in FIGS. 8 and 9 are examples of the digital TV configuration, it can be regarded as a configuration of a TV phone, so-called a TV receiver function. As the TV phone does not use a remote controller 280, some keys of a TV phone needs to take over the functions of the related keys 280a˜280f of the remote controller 280.

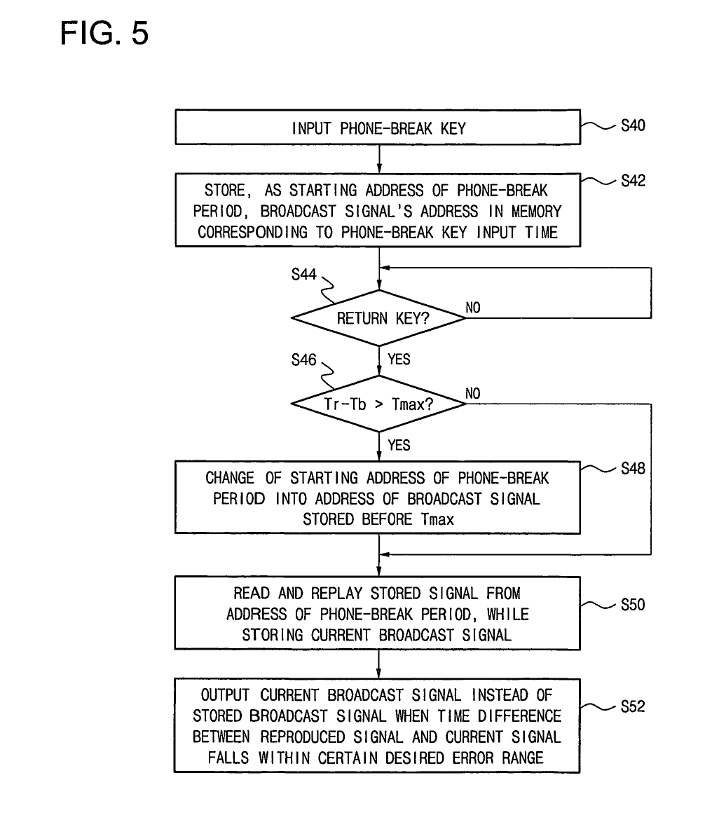

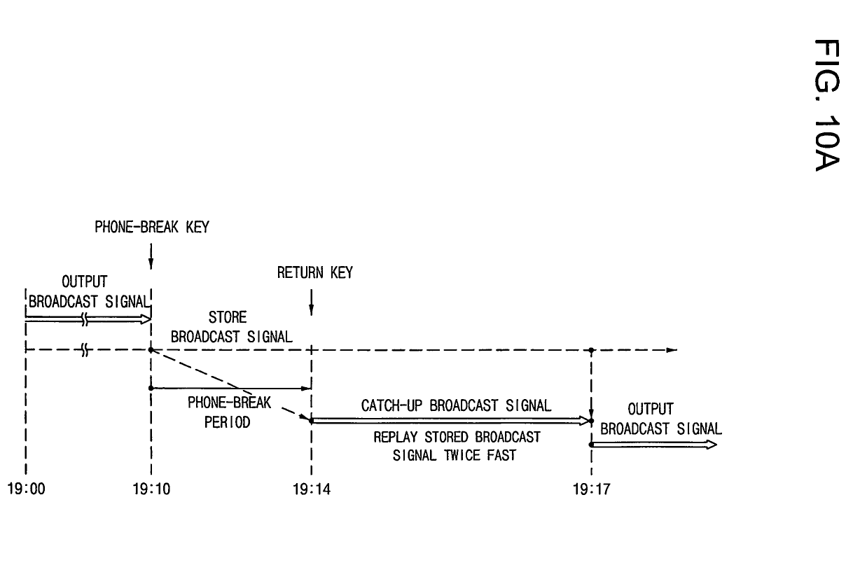

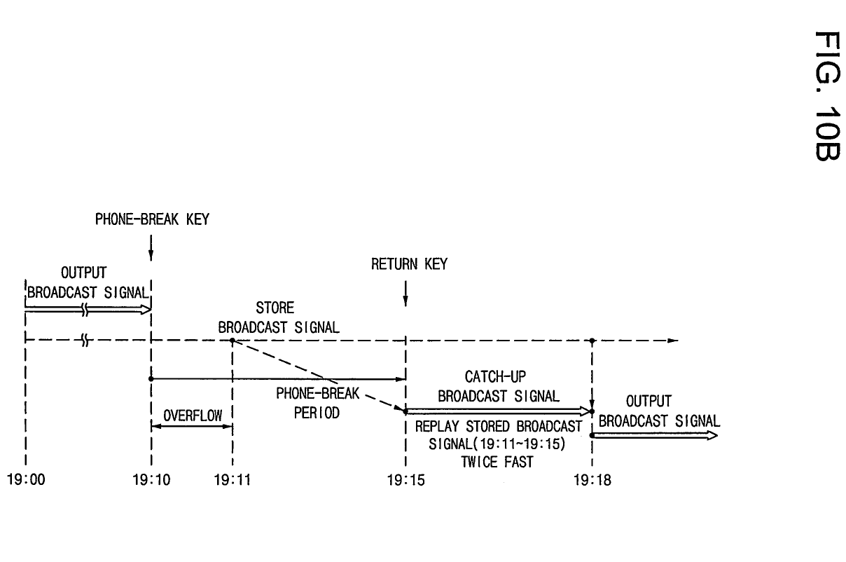

FIG. 5 is a flow chart showing the execution procedure of a phone-break period watch function. FIGS. 10a and 10b are diagrams showing the signal processing over time when executing the phone-break period watch function using a digital TV or a TV phone (generally referred to as a “digital TV”) which adopt the system 200 or 200-1 in FIG. 8 or FIG. 9. The memory 240 is assumed to have a size capable of storing a maximum 4 minutes of broadcast signals. In particular, FIG. 10a and FIG. 10b depict an example of a 4 and 5 minutes of phone-break period respectively. It is preferable to adopt the FIFO mode when storing and retrieving the broadcast signal from the memory. If the FIFO mode is used, only the broadcast signal of the latest 4 minutes is memorized in the memory 240 in FIG. 10b, and inevitably the broadcast signal of the previous one minute, i.e., the broadcast signal received from 19:10 to 19:11, is lost due to the overflow.

In case where a user needs a break, for example, because of a phone call or the like while watching TV, the phone-break key 280a is pressed (S40). It remembers the address of the memory 240 at the time the phone-break key 280a is pressed (S42) in order to read the broadcast signal later from the point where the phone-break key 280a has been pressed S42. Storing the broadcast signal must be started at least from the point where the phone-break key 280a is pressed. Irrespective of the key input, it is desirable to store the broadcast signal continuously, considering the “back and slow watch function, and the others. It is an option whether or not to output the broadcast signal received during the phone-break period to the display and the speaker.

Thereafter, as shown in FIG. 10a, if the user presses the return key 280d of the remote controller 280 at 19:14 to watch the television again after the phone call, the controller 265 controls the MPEG decoder 230 to read and decode the broadcast signal stored in memory 240. Before this operation, the controller 265 finally performs a decision process about the starting address of the memory to be decoded. That is, when the return key 280d is pressed, the period of time Tr−Tb between the input point Tr of the phone-break key 280a and the input point Tb of the return key 280d is calculated and confirmed whether it exceeds the maximum storing time Tmax (e.g. 4 minutes) of the memory 240 (S46). As shown in FIG. 10b, if Tr−Tb>Tmax, the starting address of the phone-break period is updated from the address of the current time to the address where the broadcast signal received Tmax minutes before is stored (S48). In FIG. 10b, the starting address of the phone-break period is updated to the address of the first broadcast signal (i.e., the broadcast signal received 19:11) currently stored in the memory 240, and the broadcast signal received between 19:10 and 19:11 is treated as being lost. As shown in FIG. 10b, if Tr−Tb<Tmax, it does not exceed the maximum storage capacity of phone-break period memory 240, so that the starting address of the phone-break period is not required to be updated no the data will be lost.

After the decision process of the starting address of phone-break period, the “catch up with the broadcast signal function” is executed. That is, the MPEG decoder 230 sequentially reads and decodes the broadcast signals stored in the memory 240 from the above-decided address. The video and audio signals decoded by the MPEG decoder 230 are transferred to the video time-scaler 220 and the audio time-scaler 210 respectively, and replayed in a high speed mode at the designated time-scale. The basic time-scale adopted by each time-scaler 210, 220 may be twice as fast as the normal speed, which can be changed to other values by the user using the speed control keys 280e, 280f of the remote controller 280. The video and audio signals time-scaled so as to be replayed in a high speed mode are further synchronized through the AV synchronizer 250, and output as video and audio. As understood from the above explanation, in case of the system 200-1 shown in FIG. 9, the synchronization at the AV synchronizer 250 will precede the time-scaling at the two time-scalers 210, 220.

While replaying in a high speed mode, the time difference between the broadcast signal being received currently and the reproduction signal of the broadcast signal stored in memory 240 is reduced gradually. After a certain period of time in such state, the reproduction signal almost catches up with the current broadcast signal. If the time difference between the two signals becomes so small as to be within a predefined error range, then the signal decoded by the MPEG decoder 230 is replaced with the current broadcast signal provided through the demultiplexer 245, instead of the broadcast signal stored in the memory 240. Afterwards, the current broadcast signal again is output to the digital TV display and the speaker. Whether the “catch up with the broadcast signal function” is completed or not can be judged by comparing the values of time stamps.

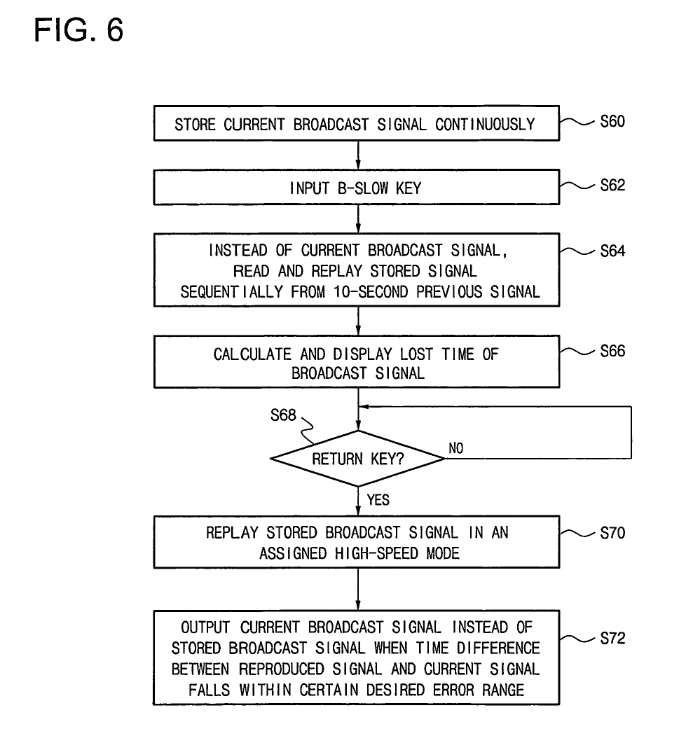

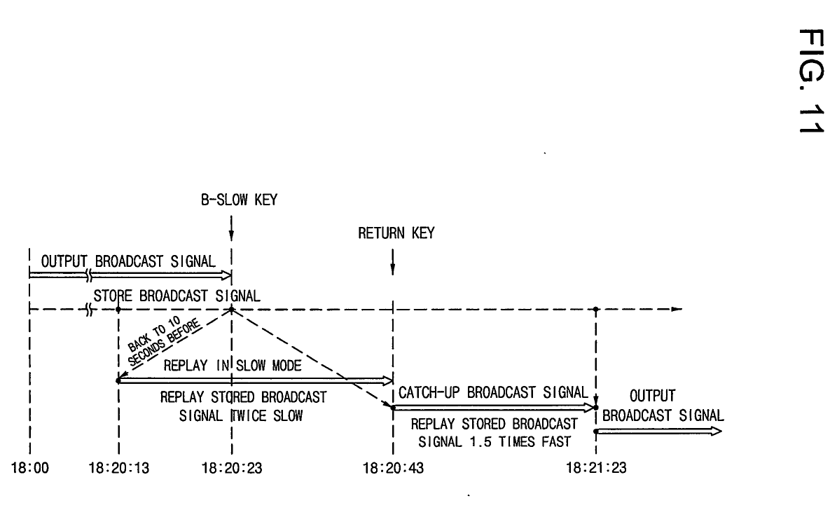

Next, FIG. 6 is a flow chart showing the execution procedures of the back-and-slow watch function, and FIG. 11 is a diagram showing the signal processing over time when executing the back-and-slow watch function. For the purpose of this function, it is necessary to store continuously the broadcast signal being received currently in the memory 240, simultaneously while decoding and outputting it in real-time (S60). For example, it is a useful function when one wishes to see a just scored goal-in scene again in more detail while watching a soccer game. In this case, it is usual to watch the scenes of several or tens of seconds again, and thus the storage capacity of storing several tens of seconds of the broadcast signal will be sufficient for the memory 240.

If the user presses the back-and-slow key 280c at 18:20:23 to see the important scene again (S62), the controller 265 recognizes the key input and controls the MPEG decoder 230 to read and decode the stored broadcast signal in the memory 240, instead of using the currently received broadcast signal provided directly from the demultiplexer 245(S64). It is programmed so as to go back to the past by some time, e.g. 10 seconds, whenever the back-and-slow key 280c is pressed. For example, if the user presses the back-and-slow key 280c once, the broadcast signal of 18:20:13 will be provided to the MPEG decoder 230, going back to the past by 10 seconds. The video and audio signals decoded at the MPEG decoder 230 are time-scaled respectively by the video time-scaler 220 and audio time-scaler 210 such that they are replayed in a low speed mode, e.g. twice slow. For the sake of the user's convenience, the time of the scene being played back and/or the time difference from the current broadcast signal can be displayed (S66).

In order to finish the low speed mode replay, the user presses the return key 280c. If the return key input is sensed, the controller 265 controls such that the broadcast signal stored in the memory 240 is played in a high speed mode in order to catch up with the current signal (S70). In the low speed mode replay of the step S64 and the high speed mode replay of the step S70, the time-scale basically applied may be set to twice fast and 1.5 times slow, which can be changed by using the buttons 280e, 280f when required by the user. Catching up with the current signal is the same as explained in connection with the step S52 of FIG. 5. For example, if the return key 280d is pressed at 18:20:43, the signal replayed in a low speed is the broadcast signal of from 18:20:13 to 18:20:20. Therefore, by reading and replaying in a high speed mode the broadcast signal stored in the memory 240 after 18:20:23, the current signal can be caught up with. For example, if the broadcast signal stored in the memory 240 is played 1.5 times fast in a high speed mode, the current broadcast signal will be caught up at 18:21:23. Thereafter, the MPEG decoder 230 decodes the broadcast signal provided directly from the demultiplexer 245.

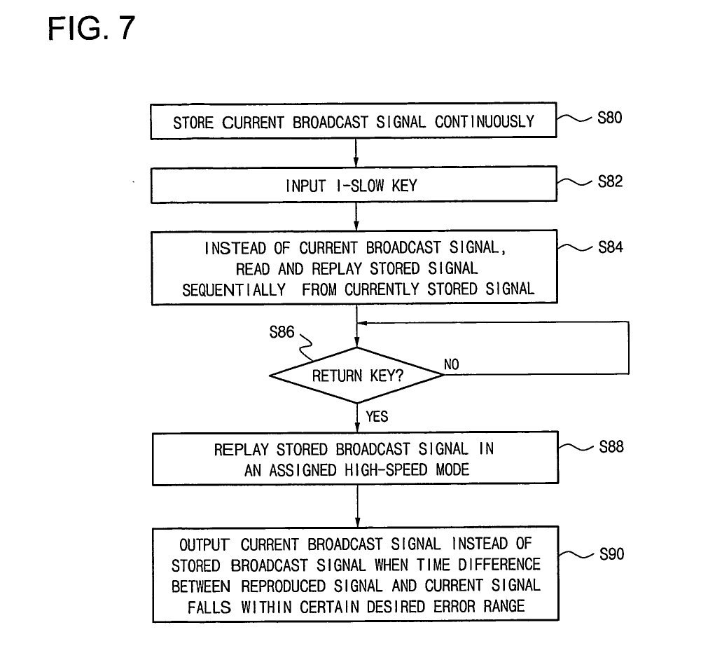

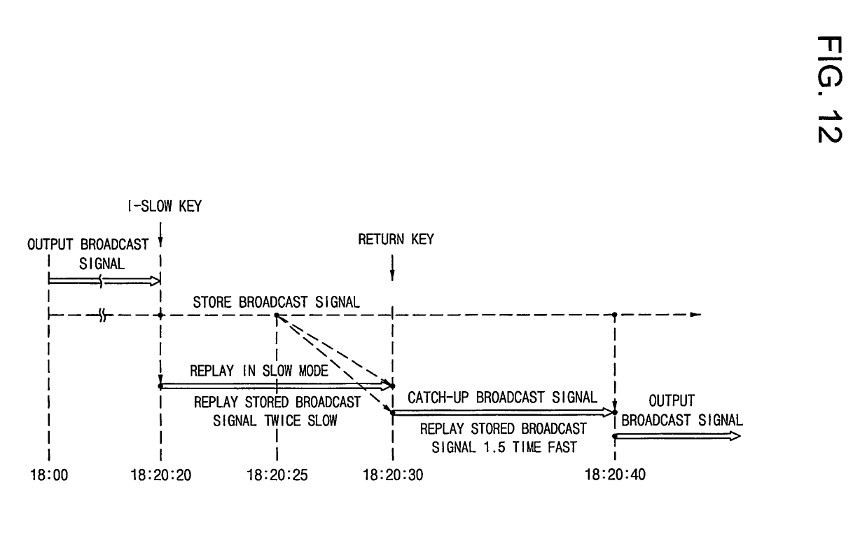

FIG. 7 is a flow chart showing the execution procedures of the immediate-slow watch function, and FIG. 12 is a diagram showing the signal processing over time when executing the immediate-slow watch function. Only for this function, it is unnecessary to store the broadcast signal into the memory 240 until the execution of this function is instructed. However, if it is provided along with the above two functions, the current broadcast signal will be continuously stored in the memory 240(S80). This function enables to watch TV in a low speed mode when needed to see a certain scene carefully while watching the TV, and, when such scenes are encountered, the user can execute this function by pressing the immediate-slow key 280b(S82). If an input of the immediate-slow 280b key is sensed, immediately the controller 265 controls the MPEG decoder 230 to read and decode the broadcast signal stored in the memory 240. The decoded video and audio signals are time-scaled respectively at the assigned time-scale by the video time-scaler 220 and the audio time-scaler 210, and the video and audio signals obtained are played in a low speed mode (S84). As explained above, if the user presses the return key 280d in order to return to the normal speed after the above low speed mode replay, the controller 265 recognizes the key press (S86) and begins to replay the broadcast signal stored in the memory 240 in a high speed mode (S88). Then, when the high speed replay of the stored signal catches up with the current broadcast signal, the controller 265 returns to the current broadcast signal by controlling the MPEG decoder 230 so as to decode the current broadcast signal (S90).

In FIG. 12, if the immediate-slow key 280b is pressed at 18:20:20 and the return key 280d is pressed at 18:20:30, and the assigned time-scales are twice slow and 1.5 times fast, then, the broadcast signal stored for 5 seconds from 18:20:20 second is replayed twice slow for 10 seconds from 20 second to 30 second, and, from the 30 second when the return key 280d is pressed, the broadcast signal stored from the 25 second is replayed 1.5 times fast. As the result, the reproduction signal can catch up with the current broadcast signal at 18:20:40. Thereafter, the current broadcast signal is output directly.

The reason why these useful additional functions are enabled is that, whatever the time-scale is, the synchronization between the AV signals can be achieved. As explained previously, the AV synchronization results from the flexibility and adaptability of the time-scale method of the audio signal according to the present invention. That is, according to the present invention, even though the replay speed of the video signal differs from the assigned time-scale, the audio signal is time-scaled based on the real time-scale of the video signal and this adaptive time-scale is applicable in real-time, so that the time-scaled video and audio signals can be continuously synchronized.

In the above description, the time-scale method of the video signal is not described specifically. There are many well-known time-scale technologies, from which an appropriate one may be selected and used. As long as it is capable of calculating the real time-scale accurately, any video signal time-scale method may be applied to the present invention.

### INDUSTRIAL APPLICABILITY

According to the TSM processing of an audio signal of the invention, once a certain time-scale is assigned, the difference between a computed reproduction time corresponding to the assigned time-scale and a real reproduction time of the time-scaled signal by the time-scale can be controlled to remain within a pre-established tiny error range. Also, even if the time-scale changes, the audio signal is TSM-processed immediately using the changed time-scale. As a result, the audio signal obtained by the TSM processing of the invention is always maintained within a narrow error range to the extend to be able to disregard, as compared with the reproduction time computed using the time-scale assigned by the user. Therefore, the present invention can accomplish a synchronization of video and audio when applied to a multi-media signal. In particular, even though the value of the real time-scale of a time-scaled signal may be deviated from the user assigned value, the TSM processing of an audio signal is adaptively performed based on the deviated value of time-scale, so that the AV synchronization in the time-scale processing needs less load. In addition, this AV signal synchronization results in useful and practical functions such as a “phone-break watch function,” a “back-and-slow watch function,” and an “immediate-slow watch function.”

The present invention may be programmed such that it can be included in a multimedia player for a personal computer, for example, can be embedded in the chip of the digital multimedia or the digital broadcast signal processor, such as a DVD player, a digital VTR, a TV phone, a PVR (personal video recorder), a MP3 player, a set-top box, etc.

While the present invention has been described with reference to several preferred embodiments, the description is illustrative of the invention and is not to be constructed as limiting the invention. Various modifications and variations may occur to those skilled in the art without departing from the scope and spirit of the invention as defined by the appended claims.

What is claimed is:

1. A time-scale modification method for a digital audio signal, in which an audio sample stream of an input signal is segmented into a plurality of overlapping analysis windows, the length of the overlapping area is changed into a length corresponding to an assigned time-scale α, and the overlapping area is weighted-synthesized to thereby be converted into a time-scaled output signal, the method comprising steps of:
a) defining N+Kmax number of samples starting from the mSa^{th} sample (m: period index) of an input audio sample as an analysis window Wₘ of current period m, wherein, if a value of a desired synthesis interval Ss divided by the time-scale α is a natural number, the value is assigned as an analysis interval Sa, and if it is a decimal, two natural numbers nearest to the decimal are assigned respectively as a modified analysis interval Sa′ and a compensated analysis interval Sa″, the modified analysis interval Sa′ and the compensated analysis interval Sa″ being alternately applied in place of the analysis interval Sa every time when a certain desired condition is met;
b) calculating a shift value Kₘ of the current period analysis window Wₘ when exhibiting a highest waveform-similarity between OV number of samples from the end of the output audio sample and OV number of samples of the current period analysis window Wₘ overlapping therewith, while shifting the starting point of the current period analysis window Wₘ by a certain predefined number of samples in a search range defined as Kmax number of samples from the OV+1^{th} sample counting from the end of an output signal of previous period m−1;
c) defining N number of samples starting from the Km+1^{th} sample from the front of the current period analysis window Wₘ as an additional frame to be added to the current period, wherein an output signal of the current period m is synthesized by overlap-adding OV number of samples from the front of the additional frame to OV number of samples from the end of the previous period frame; and
d) accumulating an error between a real reproduction time of the output signal of the current period m and a computed reproduction time calculated by the time-scale α, wherein, when the accumulated error is deviated from the upper or lower limit of an allowed error range, the certain desired condition is considered as being met.

2. A time-scale modification method according to claim 1, further comprising a step of: when the time-scale α is changed, recalculating an analysis interval Sa based on the changed time-scale, wherein a time-scale modification is processed using the changed time-scale and the recalculated analysis interval Sa.

3. A time-scale modification method according to claims 1 or 2, wherein the time-scale α includes a time-scale assigned by a user input device, or a real time-scale of a video signal provided through a time-scale process of a video signal, which is carried out along with a time-scale modification of a video signal.

4. A time-scale modification method according to claim 1, wherein plural samples are skipped when shifting the analysis window Wm within the search range Kmax at every period.

5. A time-scale modification method according to any one of claims 1 to 4, wherein the waveform-similarity is determined by a cross-correlation between the overlapping area consisting of a certain number of samples from the end of the previous period frame and the certain number of samples of the current period analysis window Wₘ of the current period, which is overlapping with the previous period frame.

6. A time-scale modification method according to claim 5, wherein, among the samples of the previous period frame and the current period analysis window, a sample whose index is multiple of k (k: a natural number larger than 2) is selected and participated in the computation of the cross-correlation.

7. A time-scale modification method for a digital audio/video signal, in which an input digital audio/video signal is separated into an audio signal and a video signal, each of which is time-scaled with a same time-scale α, the method comprising steps of:
a) calculating periodically a real time-scale of a time-scaled video signal obtained by time-scaling the video signal based on the time-scale α;
b) determining whether a real time-scale of a current period of the time-scaled video signal differs from that of a previous period, wherein, if different, the real time-scale of the current period is provided as a target time-scale α′, the target time-scale α′ becoming a reference for the time-scale modification of the audio signal; and
c) segmenting a sample stream of the input audio signal into a plurality of overlapping analysis windows, changing the length of the overlapping area into a length corresponding to the target time-scale α′, and weighted-synthesizing the overlapping area, thereby modifying into a time-scaled output audio signal.

8. A time-scale modification method according to claim 7, wherein the step c) comprises steps of:
a) defining N+Kmax number of samples starting from the mSa^{th} sample (m: period index) of the input audio signal as an analysis window Wₘ of current period m, wherein, if a value of a desired synthesis interval Ss divided by the target time-scale α′ is a natural number, the value is assigned as an analysis interval Sa, and if it is a decimal, two natural numbers nearest to the decimal are assigned respectively as a modified analysis interval Sa′ and a compensated analysis interval Sa″, the modified analysis interval Sa′ and the compensated analysis interval Sa″ being alternately applied in place of the analysis interval Sa every time when a certain desired condition is met;
b) calculating a shift value Kₘ of the current period analysis window Wₘ when exhibiting a highest waveform-similarity between OV number of samples from the end of the output audio sample and OV number of samples of the current period analysis window Wₘ overlapping therewith, while shifting the starting point of the current period analysis window Wₘ by a certain predefined number of samples in a search range defined as Kmax number of samples from the OV+1^{th} sample counting from the end of an output signal of previous period m−1;
c) defining N number of samples starting from the Km+1^{th} sample from the front of the current period analysis window Wₘ as an additional frame to be added to the current period, wherein an output signal of the current period m is synthesized by overlap-adding OV number of samples from the front of the additional frame to OV number of samples from the end of the previous period frame; and
d) accumulating an error between a real reproduction time of the output signal of the current period m and a computed reproduction time calculated by the time-scale α′, wherein, when the accumulated error is deviated from the upper or lower limit of an allowed error range, the certain desired condition is considered as being met.

9. A time-scale modification method according to claim 1, 7, or 8, wherein the real time-scale of the video signal is a ratio between an elapsed time T2-T1 from a certain point T1 in the past to a current time T2 and an elapsed time TS2-TS1 from a time stamp TS1 of a time-scaled video frame in the certain point T1 in the past to a current time stamp TS2 of a time-scaled video frame in the current time T2.

10. A time-scale modification method according to claim 7 or 8, wherein the upper and lower limit of the allowed error range is determined within an error range such that an unsynchronization between the audio and video signals is not recognized during their time-scaled reproduction.

11. A time-scale modification method according to claim 8, wherein plural samples are skipped when shifting the analysis window Wm within the search range Kmax at every period.

12. A time-scale modification method according to claim 8, wherein the waveform-similarity is determined by a cross-correlation between the overlapping area consisting of a certain number of samples from the end of a previous period frame and the certain number of samples of the current period analysis window Wₘ, which is overlapping with the previous period frame.

13. A time-scale modification method according to claim 12, wherein, among all the samples of each of the previous period frame and the current period analysis window, a sample whose index is of k (k: a natural number larger than 2) is selected and participated in the computation of the cross-correlation.

14. A method of reproducing a broadcast signal using an apparatus, which receives a transport stream of a digital television broadcast signal compressed and coded in a MPEG mode and reproduces video and audio signals in real-time, the method comprising steps of:
a) storing sequentially a digital television broadcast signal being received in a storage means at least after a user inputs a phone-break key;
b) after the user presses a return key, reading the stored broadcast signal in a FIFO mode and time-scaling the respective retrieved video and audio signals with a predetermine time-scale, wherein, in particular, the time-scaling of the audio signal is performed based on a real time-scale α of the produced video signal, the real time-scale of the video signal obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and
c) outputting the time-scaled video and audio signals in place of a broadcast signal being currently received.

15. A method according to claim 14, further comprising a step of outputting a broadcast signal being currently received instead of the stored broadcast signal, if a time difference between a broadcast signal reproduced by applying the time-scale α as a value for a high speed reproduction mode and the broadcast signal being currently received falls within a certain desired error range.

16. A method according to claim 14, further comprising a step of, when the phone-break period between the phone-break key input and the return key input exceeds the maximum storage time of the storage means, replacing with the broadcast signal being currently received the stored broadcast signal, in sequence from an earlier stored one, and changing the start address of the phone-break period from the current time into an address of a broadcast signal stored before the maximum storing time.

17. A method of reproducing a broadcast signal using an apparatus, which receives a transport stream of a digital television broadcast signal compressed and coded in a MPEG mode and reproduces video and audio signals in real-time, the method comprising steps of:
a) storing sequentially the broadcast signal in a storage means;
b) when a user's back-and-slow key input is detected, reading the stored broadcast signal in a FIFO mode, starting from a broadcast signal received before a certain period of time from that time point, and time-scaling the respective retrieved video and audio signals with a predetermine time-scale so as to enable a low speed reproduction, wherein, in particular, the time-scaling of the audio signal is performed based on a real time-scale α of the produced video signal, the real time-scale of the video signal obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and
c) outputting the time-scaled video and audio signals in place of a broadcast signal being currently received.

18. A method according to claim 17, further comprising steps of: a) when the user inputs a return key, time-scaling the stored broadcast signal for a high speed reproduction by modifying the time-scale into a value for a high speed reproduction mode, and b) outputting a broadcast signal being currently received instead of the stored broadcast signal, if a time difference between a broadcast signal being reproduced in a high speed mode and the broadcast signal being currently received falls within a certain desired error range.

19. A method of reproducing a broadcast signal using an apparatus, which receives a transport stream of a digital television broadcast signal compressed and coded in a MPEG mode and reproduces video and audio signals in real-time, the method comprising steps of:
a) storing sequentially the broadcast signal in a storage means at least after a user inputs an immediate-slow key;
b) reading the stored broadcast signal in a FIFO mode starting from the point of inputting the immediate-slow key and time-scaling the respective retrieved video and audio signals with a predetermine time-scale so as to enable a low speed reproduction, wherein, in particular, the time-scaling of the audio signal is performed based on a real time-scale α of the produced video signal, the real time-scale of the video signal obtained by the time-scaling of the video signal being calculated by applying the predetermine time-scale, an audio sample stream of an input signal is segmented into a plurality of overlapping analysis windows, the length of the overlapping area is changed into a length corresponding to the real time-scale α of the video signal, and the overlapping area is weighted-synthesized, thereby converting into a time-scaled output signal; and
c) outputting the time-scaled video and audio signals in place of a broadcast signal being currently received.

20. A method according to claim 19, further comprising steps of: a) when the user inputs a return key, time-scaling the stored broadcast signal for a high speed reproduction by modifying the time-scale into a value for a high speed reproduction mode, and b) outputting a broadcast signal being currently received instead of the stored broadcast signal, if a time difference between a broadcast signal being reproduced in a high speed mode and the broadcast signal being currently received falls within a certain desired error range.

21. A method according to claim 14, 17, or 19, wherein the time-scaling of the audio signal is carried out by steps of:
a) defining N+Kmax number of samples starting from the mSa^{th} sample (m: period index) of the input audio signal as an analysis window Wₘ of current period m, wherein, if a value of a desired synthesis interval Ss divided by the time-scale α is a natural number, the value is assigned as an analysis interval Sa, and if it is a decimal, two natural numbers nearest to the decimal are assigned respectively as a modified analysis interval Sa′ and a compensated analysis interval Sa″, the modified analysis interval Sa′ and the compensated analysis interval Sa″ being alternately applied in place of the analysis interval Sa every time when a certain desired condition is met;
b) calculating a shift value Kₘ of the current period analysis window Wₘ when exhibiting a highest waveform-similarity between OV number of samples from the end of the output audio sample and OV number of samples of the current period analysis window Wₘ overlapping therewith, while shifting the starting point of the current period analysis window Wₘ by a certain predefined number of samples in a search range defined as Kmax number of samples from the OV+1^{th} sample counting from the end of an output signal of previous period m−1;
c) defining N number of samples starting from the Km+1^{th} sample from the front of the current period analysis window Wₘ as an additional frame to be added to the current period, wherein an output signal of the current period m is synthesized by overlap-adding OV number of samples from the front of the additional frame to OV number of samples from the end of the previous period frame; and
d) accumulating an error between a real reproduction time of the output signal of the current period m and a computed reproduction time calculated by the time-scale α, wherein, when the accumulated error is deviated from the upper or lower limit of an allowed error range, the certain desired condition is considered as being met.

22. A method according to claim 14, 17, or 19, wherein further comprising a step of uncompressing and decoding the video and audio signals respectively by means of a MPEG decoder before time-scaling the broadcast signal stored in the storage means.

23. A method according to claim 14, 17, or 19, wherein the time-scaling of the video signal is performed by an adjustment of the output time interval of the video frames so as to be as fast as the time-scale, or a reduction of the number of output frames so as to be as low as the time-scale, or a combination of the above two.

24. A method according to claim 14, 17, or 19, wherein the adjustment of the output time interval of the video frames is carried out an adjustment of the value of presentation time stamp of the video frame.
